(19) United States
(12) Patent Application Publication
(10) Pub. No.: US 2014/0379941 A1
(43) Pub. Date: Dec. 25, 2014

(54) RECEIVING DEVICE, TRANSMITTING DEVICE AND TRANSMITTING/RECEIVING SYSTEM

(71) Applicant: KABUSHIKI KAISHA TOSHIBA, Tokyo (JP)

(72) Inventors: Hajime SUDA, Hamura-shi (JP); Kazuki KUWAHARA, Saitama-shi (JP); Masami TANAKA, Ome-shi (JP); Hideki MIYASATO, Yokohama-shi (JP)

(73) Assignee: KABUSHIKI KAISHA TOSHIBA, Tokyo (JP)

(21) Appl. No.: 14/209,758

(22) Filed: Mar. 13, 2014

(30) Foreign Application Priority Data
Jun. 19, 2013 (JP) 2013-128308

(51) Int. Cl. G06F 13/42

(52) U.S. Cl. CPC G06F 13/4252
USPC 710/11

(57) ABSTRACT

According to one embodiment, a receiving device configured to receive a stream transmitted from a transmitting device connected by an MHL cable in compliance with an MHL standard, including, two or more HDMI terminals, to which the MHL cable is connected, two or more MHL processors, each configured to process signals of the stream input to the HDMI terminals in compliance with an MHL standard, and a switch configured to switch connection between the terminals and one of the MHL processors based on whether the MHL cable is connected thereto.

### CROSS-REFERENCE TO RELATED APPLICATIONS

This application is based upon and claims the benefit of priority from Japanese Patent Application No. 2013-128308, filed Jun. 19, 2013; the entire contents of which are incorporated herein by reference.

### FIELD

Embodiments described herein relate generally to a receiving device, transmitting device and transmitting/receiving system.

### BACKGROUND

Electronic devices capable of recording and reproducing video content (streams) such as films and television programs and displaying video such as games have been widely used.

Such an electronic device is capable of transmitting a stream in compliance with standards such as High-definition Multimedia Interface (HDMI) and Mobile High-definition Link (MHL).

An electronic device (hereinafter referred to as a source apparatus) on the side, configured to output streams outputs a stream to an electronic device (hereinafter referred to as a sink apparatus) on the side, configured to receive streams. The sink apparatus reproduces the received stream and causes the display to display the reproduced video. When the source apparatus and the sink apparatus are connected to each other via MHL, the apparatuses are capable of mutually operating and controlling each other.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a system for transmitting and receiving according to an embodiment;

FIG. 2 is an exemplary diagram showing an example of a video processing apparatus according to an embodiment;

FIG. 3 is an exemplary diagram showing an example of a mobile terminal according to an embodiment;

FIG. 4 is an exemplary diagram showing an example of a system for transmitting and receiving according to an embodiment;

FIG. 5 is an exemplary diagram showing an example of a system for transmitting and receiving according to an embodiment;

FIG. 6 is an exemplary diagram showing an example of a process for transmitting and receiving according to an embodiment;

FIG. 7 is an exemplary diagram showing an example of a system for transmitting and receiving according to an embodiment;

FIG. 8 is an exemplary diagram showing an example of a process for transmitting and receiving according to an embodiment; and

FIG. 9 is an exemplary diagram showing an example of a process for transmitting and receiving according to an embodiment.

### DETAILED DESCRIPTION

Various embodiments will be described hereinafter with reference to the accompanying drawings.

In general, according to one embodiment, a receiving device configured to receive a stream transmitted from a transmitting device connected by an MHL cable in compliance with an MHL standard, comprising: two or more HDMI terminals, to which the MHL cable is connected; two or more MHL processors, each configured to process signals of the stream input to the HDMI terminals in compliance with an MHL standard; a reproduction module configured to reproduce content; and a switch configured to switch connection between the terminals and one of the MHL processors based on whether the MHL cable is connected thereto.

Embodiments will now be described hereinafter in detail with reference to the accompanying drawings.

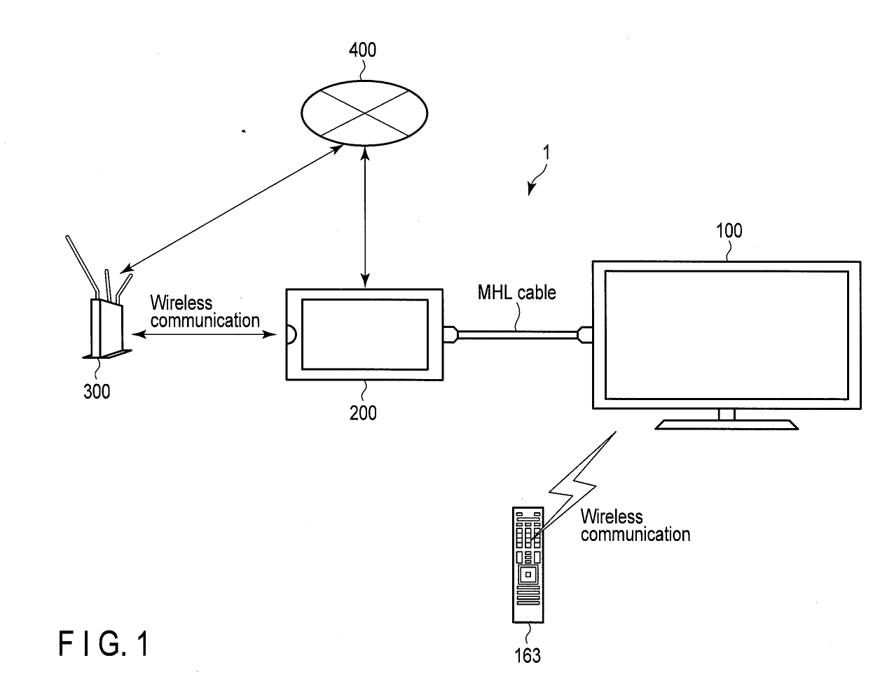

FIG. 1 shows an example of a transmitting and receiving system 1 comprising a plurality of electronic devices.

The transmitting and receiving system 1 comprises, for example, a video processing apparatus (source apparatus) 100, a portable terminal (sink apparatus) 200, and a wireless communication terminal 300.

The video processing apparatus 100 is an electronic device such as a broadcast signal receiving device configured to reproduce, for example, broadcast signals or video contents stored on recording media. The video processing apparatus 100 is capable of wireless communications with a remote controller 163.

The portable terminal 200 is an electronic device comprising a display, operation module and communication module. The portable terminal 200 is an, for example, a mobile telephone terminal, a tablet PC, a mobile music player, a game console, a digital versatile disk (DVD) recorder, a set top box (STB).

The wireless communication terminal 300 is capable of performing wired or wireless communications with each of the video processing apparatus 100 and the portable terminal 200. That is, the wireless communication terminal 300 functions as an access point (AP) of wireless communications. Further, the wireless communication terminal 300 is capable of connecting to a cloud service (a variety of servers), for example, via a network 400. That is, the wireless communication terminal 300 is capable of accessing the network 400 in response to a request from the video processing apparatus 100 or the portable terminal 200. Thereby, the video processing apparatus 100 and the portable terminal 200 are capable of acquiring a variety of data from a variety of servers on the network 400 (or a cloud service) via the wireless communication terminal 300.

The video processing apparatus 100 is mutually connected to the portable terminal 200 via a communication cable (hereinafter referred to as MHL cable) 10 compatible with the Mobile High-definition Link (MHL) standard. The MHL cable 10 is a cable including a High-definition Digital Multimedia Interface (HDMI) terminal having a shape compatible with the HDMI standard on one end, and a Universal Serial Bus (USB) terminal having a shape compatible with the USB standard, such as the Micro-USB standard, on the other end.

The MHL standard is an interface standard which allows users to transmit moving image data (streams) including video and moving images. According to the MHL standard, an electronic device (source apparatus) on the side that outputs stream outputs a stream to an electronic device (sink apparatus) on the side that receives a stream, via an MHL cable. The sink apparatus is capable of reproducing the received stream and causing the display to display the reproduced video. Further, the source apparatus and the sink apparatus are capable of operating and controlling each other, by transmitting a command to the counterpart apparatus connected via the MHL cable 10.

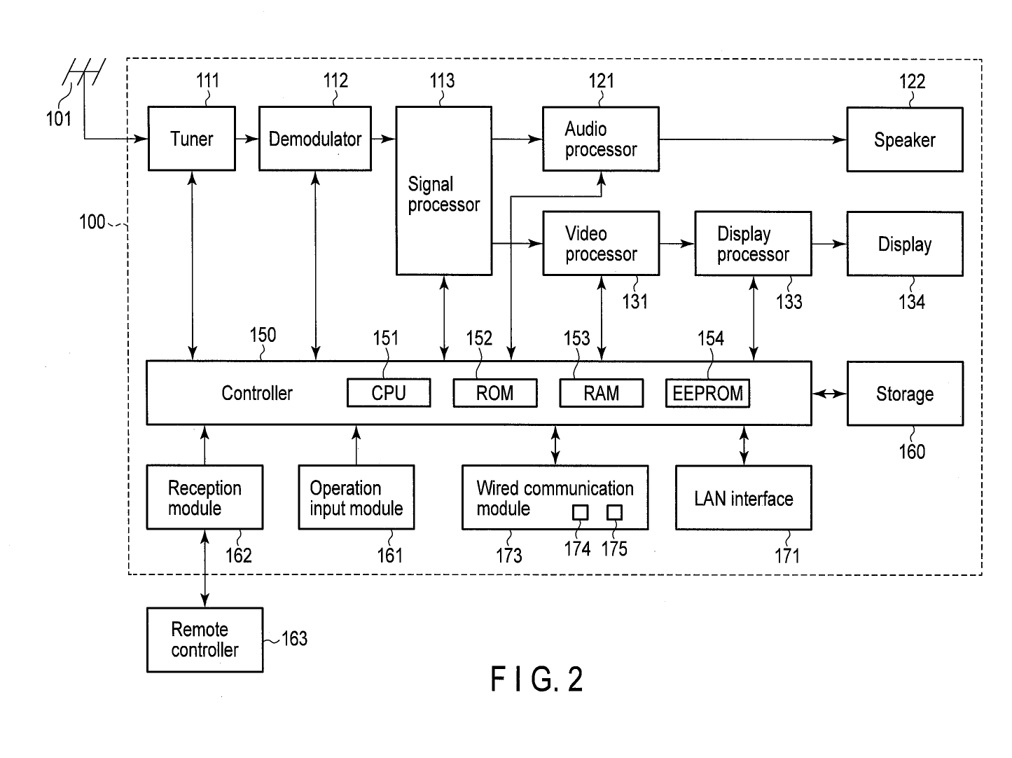

FIG. 2 shows an example of the video processing apparatus 100.

The video processing apparatus 100 is an is an electronic device such as a broadcast signal receiving device configured to reproduce, for example, broadcast signals or video contents stored on recording media or a recorder configured to record such signals.

The video processing apparatus 100 comprises a tuner 111, demodulator 112, signal processing module 113, audio processor 121, video processor 131, display processor 133, controller 150, storage 160, operation input module 161, reception module 162, LAN interface 171 and wired communication module 173. Further, the image processing device 100 comprises a loudspeaker 122 and display 134.

The tuner 111 is configured to receive digital broadcast signals received by an antenna 101, for example. The antenna 101 is configured to receive, for example, digital terrestrial broadcast signals, broadcasting satellite (BS) digital broadcast signals and/or 110 degrees east longitude degree communication satellite (CS) digital broadcasting signals. The tuner 111 is capable of receiving data (stream) of, for example, program contents supplied in the above-mentioned digital broadcast signals.

The tuner 111 is a tuner for digital broadcast signals. The tuner 111 tunes itself to digital broadcast signals received (that is, channel selection). Then, the tuner 111 transmits the digital broadcast signals to the demodulator 112. The video processing apparatus 100 may comprise a plurality of tuners 111. With the plurality of tuners, the video processing apparatus 100 can select a plurality of broadcast signals at the same time.

The demodulator 112 is configured to demodulate the digital broadcast signals received. Thus, the demodulator 112 acquires moving image data (to be referred to as “stream(s)” hereinafter) such as transport streams (TS) from the digital broadcast signals. The demodulator 112 inputs the acquired stream to the signal processor 113. It should be noted that the video processing apparatus 100 may comprise a plurality of demodulators 112. The plurality of demodulators 112 can demodulate a plurality of broadcast signals selected by the plurality of tuners 111, respectively.

As described above, the antenna 101, tuner 111 and demodulator 112, as a whole, function as a receiver unit configured to receive streams.

The signal processor 113 is configured to carry out signal processing such as separation of a stream. More specifically, the signal processor 113 is configured to separate a digital video signal, digital audio signal and other data signals from a stream. Note that the signal processor 113 is capable of handling for separation a plurality of streams each demodulated by the plurality of demodulators 112, respectively. Then, the signal processor 113 is configured to supply digital audio signals to the audio processor 121. Further, the signal processor 113 is configured to supply data signals to the controller 150.

The signal processor 113 is capable of converting the stream into data (recording stream) in a recordable state based on control by the controller 150. Further, the signal processor 113 is capable of supplying the storage 160 or other modules with a recording stream based on control by the controller 150.

Moreover, the signal processor 113 is capable of converting (transcoding) a bit rate of the stream from a bit rate set originally (in the broadcast signal/content) into a different bit rate. That is, the signal processor 113 is capable of transcoding (converting) the original bit rate of the acquired broadcast signal/content into a bit rate lower than the original bit rate. Thereby, the signal processor 113 is capable of recording content (a program) with less capacity.

The audio processor 121 is configured to convert a digital audio signal received by the signal processor 113 into a signal (audio signal) in a format that can be reproduced by the speaker 122. That is, the audio processor 121 comprises a digital-to-analog (D/A) converter and is configured to convert the digital audio signal into an analog audio (acoustic sound)/speech signal. The audio processor 121 is configured to supply the speaker 122 with the converted audio (acoustic sound)/speech signal. The speaker 122 is configured to reproduce the audio and the acoustic sound based on the supplied audio (acoustic sound)/speech signal.

The video processor 131 is configured to convert the digital video signal from the signal processor 113 into a video signal in a format that can be reproduced by the display 134. That is, the video processor 131 is configured to decode the digital video signal received from the signal processor 113 into a video signal in a format that can be reproduced by the display 134. The video processor 131 is configured to output the decoded video signal to the displaying processor 133.

The displaying processor 133 is configured to adjust color, brightness, sharpness, contrast, or other image qualities of the received video signal based on control by the controller 150, for example. The displaying processor 133 is configured to supply the display 134 with the video signal subjected to image quality adjustment. The display 134 is configured to display video images based on the supplied video signal.

The display 134 comprises a liquid crystal display panel comprising a plurality of pixels arranged in a matrix pattern and a liquid crystal display device including a backlight which illuminates the liquid crystal panel, for example. The display 134 is configured to display video images based on the video signal supplied from the displaying processor 133.

Alternatively, the video processing apparatus 100 may be configured to comprise an output terminal configured to output a video signal, in place of the display 134. Further, the video processing apparatus 100 may be configured to comprise an output terminal configured to output an audio signal, in place of the speaker 122. Moreover, the video processing apparatus 100 may be configured to comprise an output terminal configured to output a digital video signal and a digital audio signal.

The controller 150 functions as a control unit configured to control an operation of each element of the video processing apparatus 100. The controller 150 includes a CPU 151, a ROM 152, a RAM 153, an EEPROM (non-volatile memory) 154, and the like. The controller 150 is configured to perform a variety of processes based on an operation signal supplied from the operation input module 161.

The CPU 151 comprises, for example, a computing element configured to perform a variety of computing operations. The CPU 151 embodies a variety of functions by performing programs stored in the ROM 152, the EEPROM 154, or the like.

The ROM 152 is configured to store programs for controlling the video processing apparatus 100, and to program for embodying a variety of functions, and the like. The CPU 151 activates the programs stored in the ROM 152 based on the operation signal supplied from the operation input module 161. Thereby, the controller 150 controls an operation of each element.

The RAM 153 functions as a work memory of the CPU 151. That is, the RAM 153 is configured to store a result of computation by the CPU 151, data read by the CPU 151, and the like.

The EEPROM 154 is a non-volatile memory configured to store a variety of setting information, programs, and the like.

The storage 160 comprises a storage medium configured to store content. The storage 160 is, for example, a hard disk drive (HDD), a solid-state drive (SSD), a semiconductor memory, or the like. The storage 160 is capable of storing a recorded stream, text data, and the like supplied from the signal processor 113.

The operation input module 161 comprises an operation key, a touchpad, or the like, configured to generate an operation signal in response to an operation input from the user, for example. The operation input module 161 may be configured to receive an operation signal from a keyboard, a mouse, or other input devices capable of generating an operation signal. The operation input module 161 is configured to supply the controller 150 with the operation signal.

A touchpad comprises a device configured to generate positional information based on a capacitance sensor, a thermo-sensor, or other systems. When the video processing apparatus 100 comprises the display 134, the operation input module 161 may be configured to comprise a touch panel formed integrally with the display 134.

The reception module 162 comprises, for example, a sensor configured to receive the operation signal from the remote controller. The reception module 162 is configured to supply the received signal to the controller 150. The controller 150 is configured to receive the signal supplied from the reception module 162 and amplify the received signal for A/D conversion, thereby decoding the signal into the original operation signal transmitted from the remote controller 163.

The remote controller 163 is configured to generate an operation signal based on an operation input from the user. The remote controller 163 is configured to transmit the generated operation signal to the reception module 162 via infrared communications. The reception module 162 and the remote controller 163 may be configured to transmit and receive an operation signal via other wireless communications using radio waves, for example.

The local area network (LAN) interface 171 is capable of performing communications with other devices on the network 400 via the wireless communication terminal 300 by a LAN or a wireless LAN. Thereby, the video processing apparatus 100 is capable of performing communications with other devices connected to the wireless communication terminal 300. For example, the video processing apparatus 100 is capable of acquiring a stream recorded in a device on the network 400 via the LAN interface 171, and reproducing the acquired stream.

The wired communication module 173 is an interface configured to perform communications based on standards such as HDMI and MHL. The wired communication module 173 comprises an HDMI terminal, not shown, to which an HDMI cable or an MHL cable can be connected, an HDMI processor 174 configured to perform signal processing based on the HDMI standard, and an MHL processor 175 configured to perform signal processing based on the MHL standard.

A terminal of the MHL cable that is connected to the video processing apparatus 100 has a structure compatible with the HDMI cable. The MHL cable comprises a resistance between terminals (detection terminals) that are not used for communications. The wired communication module 173 is capable of determining whether the MHL cable or the HDMI cable is connected to the HDMI terminal by applying a voltage to the detection terminal.

The video processing apparatus 100 is configured to received a stream output from a device (source device) connected to the HDMI terminal of the wired communication module 173, and reproduce the received stream.

The controller 150 is configured to cause the signal processor 113 to input a stream received by the wired communication module 173. The signal processor 113 is configured to separate a digital video signal, a digital audio signal, and the like from the received stream. The signal processor 113 is configured to transmit the separated digital video signal to the video processor 131, and the separated digital audio signal to the audio processor 121. Thereby, the video processing apparatus 100 is capable of reproducing the stream received by the wired communication module 173.

Moreover, the video processing apparatus 100 comprises a power source (not shown). The power source receives power from a commercial power or the like. The power source is configured to convert an AC power received into a DC, and supply the DC-converted power to each element of the video processing apparatus 100.

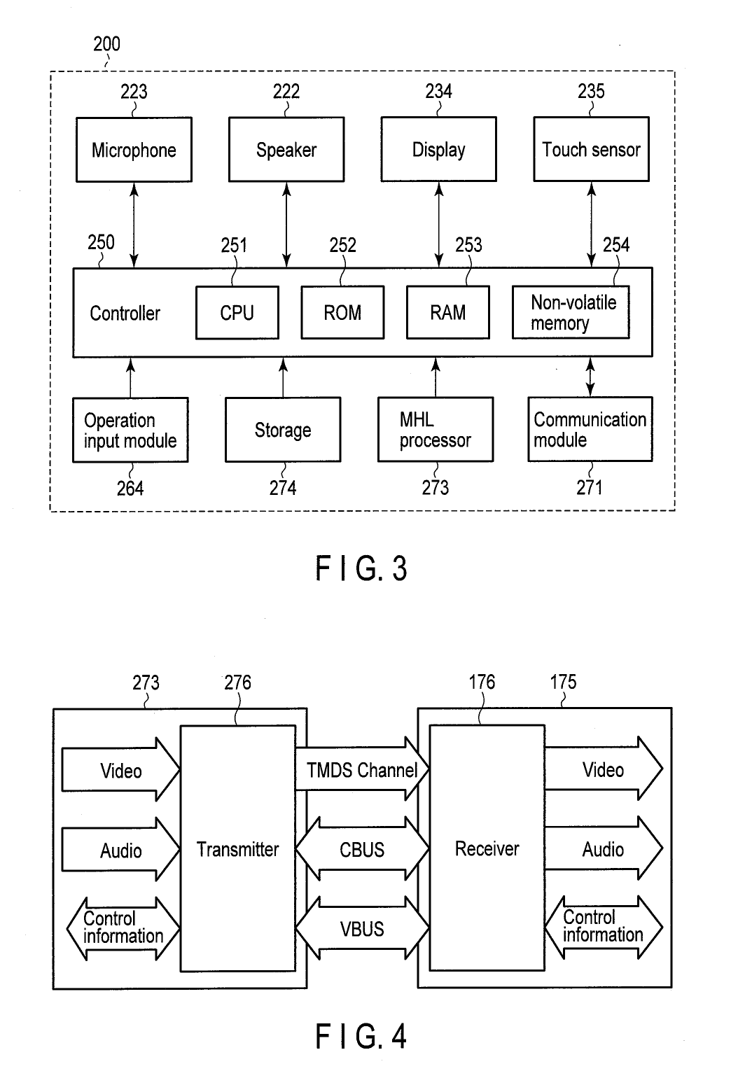

FIG. 3 is an exemplary diagram of the portable terminal 200.

The portable terminal 200 comprises a controller 250, an operation entry module 164, a communication module 271, an MHL processor 273 and a storage device 274. The portable terminal 200 further comprises a speaker 222, a microphone 223, a display 234 and a touch sensor 235.

The controller 250 functions as a controller configured to control each element of the portable terminal 200. The controller 250 comprises a CPU 251, a ROM 252, a RAM 253 and a non-volatile memory 254. The controller 250 is configured to perform a variety of processes based on an operation signal supplied from the operation entry module 164 or touch sensor 235.

The CPU 251 comprises a computing element configured to execute a variety of computing operations. The CPU 251 embodies a variety of functions by executing programs stored in the ROM 252 or the non-volatile memory 254, for example.

The ROM 252 is configured to store programs for controlling the portable terminal 200, programs for embodying a variety of functions, and the like. The CPU 251 is configured to activate the programs stored in the ROM 252 based on an operation signal from the operation input module 264. Thereby, the controller 250 controls an operation of each element.

The RAM 253 functions as a work memory of the CPU 251. That is, the RAM 253 is configured to store a result of computation by the CPU 251, data read by the CPU 251, and the like.

The non-volatile memory 254 is a non-volatile memory configured to store a variety of setting information, programs, and the like.

The CPU 251 is capable of executing a variety of processes based on data such as the applications stored in the storage device 274.

The controller 250 is capable of generating video signals for display on various types of screens, for example, and display the video image on the display 234 based on the application being executed by the CPU 251.

The speaker 222 is configured to reproduce sound based on an audio signal supplied.

The microphone 223 is a module configured to generate a signal (recording signal) based on an external sound of the mobile terminal 200. The microphone 223 is configured to supply the recording signal to the controller 250.

The display 234 comprises, for example, a liquid crystal display panel comprising a plurality of pixels arranged in a matrix pattern and a liquid crystal display device comprising a backlight configured to illuminate the liquid crystal panel. The display 234 is configured to display a video image based on the video signal.

The touch sensor 235 is a device configured to generate positional information based on a capacitance sensor, a thermo-sensor, or other systems. The touch sensor 235 is provided integrally with the display 234, for example. Thereby, the touch sensor 235 is capable of generating an operation signal based on an operation on a screen image displayed on the display 234 and supplying the generated operation signal to the controller 250.

The operation input module 264 comprises a key configured to generate an operation signal in response to an operation input from the user, for example. The operation input module 264 comprises a volume adjustment key configured to adjust the volume, a brightness adjustment key configured to adjust the display brightness of the display 234, a power-supply key configured to switch the power states of the portable terminal 200, and the like. The operation input module 264 may further comprise, for example, a trackball configured to cause the portable terminal 200 to perform a variety of selection operations. The operation input module 264 is configured to generate an operation signal according to an operation of the key, and supply the controller 250 with the operation signal.

The operation input module 264 may be configured to receive an operation signal from a keyboard, a mouse, or other input devices capable of generating an operation signal. For example, when the portable terminal 200 comprises a USB terminal or a module which embodies a Bluetooth (registered trademark) process, the operation input module 264 is configured to receive an operation signal from an input device connected via USB or Bluetooth, and supply the received operation signal to the controller 250.

The communication module 271 is capable of performing communications with other devices on the network 400 via the wireless communication terminal 300, using a LAN or a wireless LAN. Further, the communication module 271 is capable of performing communications with other devices on the network 400 via a portable telephone network. Thereby, the portable terminal 200 is capable of performing communications with other devices connected to the wireless communication terminal 300. For example, the portable terminal 200 is capable of acquiring moving images, pictures, music data, and web content recorded in devices on the network 400 via the communication module 271 and reproducing the acquired content.

The MHL processor 273 is an interface configured to perform communications based on the MHL standard. The MHL processor 273 is configured to perform signal processing based on the MHL standard. The MHL processor 273 includes a USB terminal, not shown, to which an MHL cable can be connected.

The mobile terminal 200 is capable of outputting a stream to a device (sink apparatus) connected to a USB terminal of the MHL processor 273.

Further, the MHL processor 273 is capable of creating a stream by superimposing a video signal to be displayed and an audio signal to be reproduced.

For example, the controller 250 is configured to supply the MHL processor 273 with a video signal to be displayed and an audio signal to be reproduced, when an MHL cable is connected to the USB terminal of the MHL processor 273 and the portable terminal 200 operates as a source apparatus. The MHL processor 273 is capable of generating a stream in a variety of formats (for example, 1080i and 60 Hz) using the video signal to be displayed and the audio signal to be reproduced. The controller 250 is capable of outputting the generated stream to the sink apparatus connected to the USB terminal.

Further, the portable terminal 200 comprises a power source (not shown). The power source further comprises a battery and a terminal (for example, DC jack) configured to connect the source to an adaptor to receive power from a commercial power or the like. The power source is configured to supply the power charged in the battery to each element of the mobile terminal 200.

The storage 274 comprises a hard disk drive (HDD), a solid-state drive (SSD), a semiconductor memory, and the like. The storage 274 is capable of storing contents such as moving images, programs, applications, that are executed by the CPU 251 of the controller 250, a variety of data, and the like.

FIG. 4 is an exemplary diagram illustrating mutual communications between the electronic devices based on the MHL standard. In FIG. 4, the portable terminal 200 is a source apparatus, and the video processing apparatus 100 is a sink apparatus, for example.

The MHL processor 273 of the mobile terminal 200 comprises a transmitter 276, whereas the MHL processor 175 of the image processing module 100 comprises a receiver 176.

The transmitter 276 and the receiver 176 are connected to each other via an MHL cable. The MHL cable comprises lines such as of VBUS, GND, CBUS, MHL+ and MHL−.

The VBUS line is configured to transmit power. For example, the sink apparatus is configured to supply power of +5 V to the source device via the VBUS line. The source device can operate on the power supplied from the sink apparatus via the VBUS line. For example, the power source of the mobile terminal 200, which is the source device, is capable of charging the battery with the power supplied from the sink apparatus via the VBUS line. The GND is a grounded line.

The CBUS line is configured to transmit a control signal such as a command. The CBUS line is used to transmit, for example, a display data channel (DDC) command or an MHL sideband channel (MSC) command, bidirectionally. The DDC command is used to read Extended Display Identification Data (EDID) and for authentication of High-bandwidth Digital Content Protection (HDCP), for example. The EDID is a list of display information preset in compliance with the specification of the display, for example. Further, the MSC command is used for read/write of a variety of types of registers (now shown) and remote control thereof, for example.

For example, the image processing apparatus 100, which is the sink apparatus, is configured to output a command to the mobile terminal 200, which is the source device in this embodiment, via the CBUS line. The mobile terminal 200 is capable of executing a variety of processes according to the received command.

The source device is configured to transmit the DDC command to the sink apparatus and thus execute the HDCP authentication with the sink apparatus. Thereby, the EDID can be read from the sink apparatus.

The HDCP is a system of encryption of signals transmitted between devices and apparatus. The image processing apparatus 100 and the mobile terminal 200 transmit and receive signals, for example, keys according to the procedure in compliance with the HDCP, and thus they carry out authentication with regard to each other. When the mutual authentication is confirmed, the image processing apparatus 100 and the mobile terminal 200 transmit and receive encrypted signals with each other.

The portable terminal 200 is configured to analyze the EDID acquired from the video processing apparatus 100 and to recognize display information indicating a format including a resolution, a color depth, a transmission frequency, and the like that can be processed by the video processing apparatus 100. The portable terminal 200 generates a stream in a format including a resolution, a color depth, a transmission frequency, and the like that can be processed by the video processing apparatus 100.

The MHL+ and the MHL− are lines for transmitting data. The two lines of MHL+ and the MHL− function as a twist pair. For example, the MHL+ and the MHL− function as a transition minimized differential signaling (TMDS) channel which transmits data in the TMDS system. Further, the MHL+ and the MHL− are capable of transmitting a synchronization signal (MHL clock) in the TMDS system.

For example, the source apparatus is capable of outputting a stream to the sink apparatus via the TMDS channel. That is, the portable terminal 200 which functions as the source apparatus is capable of transmitting a stream obtained by converting video (display screen) to be displayed on the display 234 and the audio to be output from the speaker 222 to the video processing apparatus 100 as the sink apparatus. The video processing apparatus 100 is configured to receive the stream transmitted using the TMDS channel, perform signal processing of the received stream, and reproduce the stream.

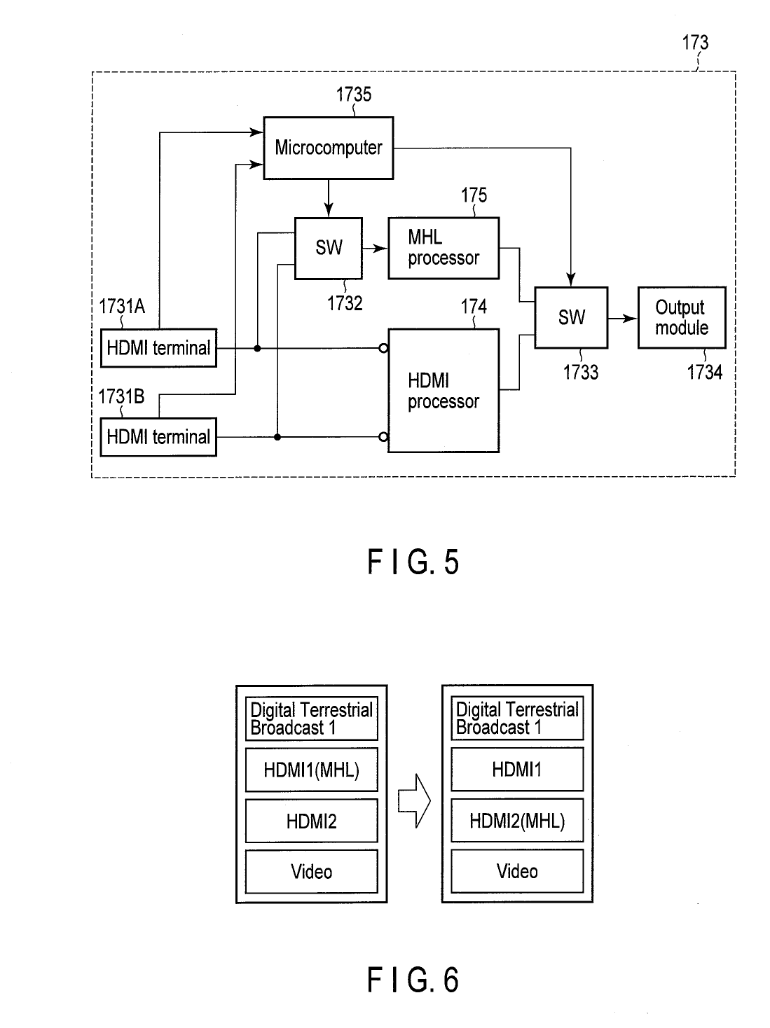

FIG. 5 shows an example of the wired communication module 173 of the image processing apparatus 100.

The wired communication module 173, as described above, comprises the HDMI processor 174 and the MHL processor 175. Further, the wired communication module 173 comprises a plurality of HDMI terminals 1731A and 1731B (, which will be referred to as HDMI terminals 1731 as a whole hereinafter). On the other hand, the wired communication module 173 comprises switches (SW) 1732 and 1733, an output module 1734 and a microcomputer 1735. Note here that the HDMI processor 174, the MHL processor 175, the SW 1732 and SW 1733, the output module 1734 and the microcomputer 1735 may be formed as an integrated unit within one IC chip.

The HDMI terminals 1731A and 1731B are connected to the HDMI processor 174. Further, outputs of the HDMI terminals 1731A and 1731B are connected to the SW 1732 as well. In other words, the SW 1732 comprises two input terminals connected respectively to the HDMI terminals 1731A and 1731B.

Further, an output terminal of the SW 1732 is connected to the MHL processor 175. The SW 172 is configured to switch the connection of one of the two input terminals to the output terminal, to the other. In other words, the SW 1732 is configured to connect one of the HDMI terminal 1731A and HDMI terminal 1731B to the MHL processor 175. The SW 1732 is configured to perform switching operation of the HDMI terminals 1731 connected to the MHL processor 175 based on the control of the microcomputer 135.

Output terminals of the HDMI processor 174 and the MHL processor 175 are connected respectively to the two input terminals of the SW 1733. Further, an output terminal of the SW 1733 is connected to an output module 1734. The SW 1733 is configured to switch the connection of one of the two input terminals to the output terminal to the other input terminal. That is, through the SW 1733, the output of the MHL processor 175 or that of the HDMI processor 174 is supplied to the output module 1734. Note that the SW 1733 is configured to perform such switching operation as to whether the output of the HDMI processor 174 or the output of the MHL processor 175 should be connected to the output module 1734 based on the control of the controller 150 or the microcomputer 135. The output module 1734 is configured to output an input signal to the controller 150.

The microcomputer 1735 is configured to judge whether or not an MHL cable is connected to the HDMI terminals 1731. More specifically, the microcomputer 135 is configured to judge whether or not the MHL cable is connected to the HDMI terminal 1731A. Further, the microcomputer 1735 is configured to judge whether or not the MHL cable is connected to the HDMI terminal 1731B.

The microcomputer 1735 is configured to control the SW 1732 based on whether or not an MHL cable is connected to the HDMI terminals 1731. For example, the microcomputer 1735, when it judges that an MHL cable is connected to the HDMI terminal 1731A, controls the SW 1732 such as to input the output of the HDMI terminal 1731A to the MHL processor 175. In other words, the microcomputer 1735, when it judges that an MHL cable is connected to the HDMI terminal 1731A, controls the SW 1732 such as to input the output of the HDMI terminal 1731A to the MHL processor 175. Further, the microcomputer 1735, when it judges that an MHL cable is connected to the HDMI terminal 1731B, controls the SW 1732 such as to input the output of the HDMI terminal 1731B to the MHL processor 175. That is, the microcomputer 1735 is configured to control the SW 1732 such as to input the outputs of the HDMI terminals 1731 to which MHL cables are connected, to the MHL processor 175.

In this manner, the wired communication module 173 is capable of inputting a stream supplied from the source apparatus via the HDMI terminals 1731 to the MHL processor 175. The wired communication module 173 is configured to change over the connections between each one of the HDMI terminals 1731 and the MHL processor 175 by means of the switch, and therefore it is cable of processing the stream supplied to any one of the HDMI terminals 1731 by the MHL processor 175 solely.

With the above-described configuration, even in the case where the MHL cable connected to one HDMI terminal “HDMI1” is reconnected to another HDMI terminal “HDMI2” as shown in FIG. 6, the video processing apparatus 100 is able to reproduce the stream.

In other words, even in the case where an MHL cable is connected to any one of the HDMI terminals, the wired communication module 173 is capable of connecting the MHL-cable connected HDMI terminal 1731 and the MHL processor 175 to each other. Thus, the user is able to connect an MHL cable to the video processing apparatus 100 without having to care about any HDMI terminal 1731 corresponding to the MHL cable.

Consequently, a receiving device, transmitting device and receiving/transmitting system of low cost and high convenience can be achieved.

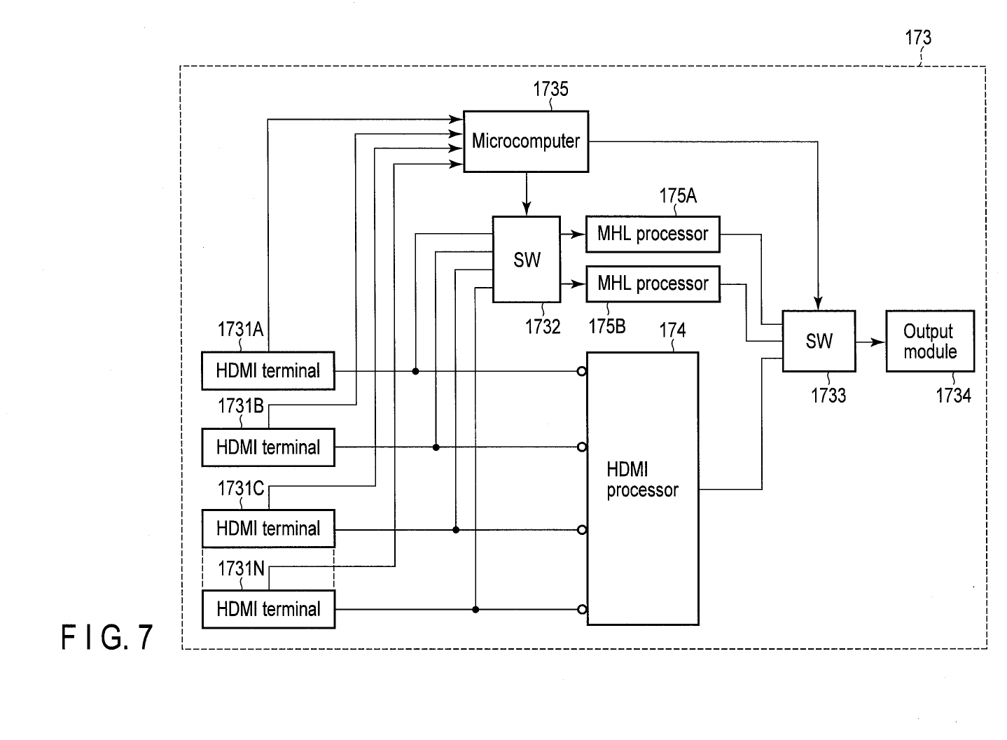

FIG. 7 shows another example of the wired communication module 173 of the image processing apparatus 100.

The wired communication module 173 comprises the HDMI processor 174 as described above, and a plurality of MHL processing modules 175A and 175B. Further, the wired communication module 173 comprises a plurality of HDMI terminals 1731A, 1731B, 1731C to 1731N (, which will be referred to as HDMI terminals 1731 as a whole hereinafter). On the other hand, the wired communication module 173 comprises switches (SW) 1732 and 1733, an output module 1734 and a microcomputer 1735. Note here that the HDMI processor 174, the MHL processor 175, the SW 1732 and SW 1733, the output module 1734 and the microcomputer 1735 may be formed as an integrated unit within one IC chip.

The HDMI terminals 1731A, 1731B, 1731C to 1731N are connected to the HDMI processor 174. Further, outputs of the HDMI terminals 1731A, 1731B, 1731C to 1731N are connected to the SW 1732 as well. In other words, the SW 1732 comprises N-number of input terminals connected respectively to the HDMI terminals 1731A and 1731B.

Two output terminals of the SW 1732 are connected to the MHL processor 175A and the MHL processor 175B respectively. The SW 1732 switches over the connection between, for example, the four input terminals and, for example, the two output terminals. Specifically, the SW 1732 switches the connection between the HDMI terminals 1731A, 1731B, 1731C to 1731N and the MHL processing modules 175A and 175B. Based on control by the microcomputer 1735, the SW 1732 switches over the HDMI terminals 1731 connected to the plurality of MHL processing modules 175.

With the above configuration, the SW 1732 is capable of connecting two of the HDMI terminals 1731A, 1731B, 1731C to 1731N to the MHL processor 175A and the MHL processor 175B.

The output terminals of the HDMI processor 174, the MHL processor 175A and the MHL processor 175B are connected to three input terminals of the SW 1733, respectively. The output terminal of the SW 1733 is connected to the output module 1734. The SW 1733 switches the connection between, for example, one of the three input terminals and the output terminal. Thus, the SW 1733 supplies output of the HDMI processor 174, output of the MHL processor 175A or output of the MHL processor 175B to the output module 1734. Based on control by the controller 150 or the microcomputer 1735, the SW 1733 selects whether the output of the HDMI processor 174 or the output of the MHL processor 175A or the output of the MHL processor 175B should be connected to the output module 1734 by switching. The output module 1734 outputs the input signal to the controller 150.

The microcomputer 1735 determines whether or not an MHL cable is connected to the HDMI terminals 1731. Specifically, the microcomputer 1735 determines whether or not an MHL cable is connected to each of the HDMI terminals 1731A to 1731D.

The microcomputer 1735 controls the SW 1732 based on whether or not an MHL cable is connected to the HDMI terminals 1731. For example, if it is determined that an MHL cable is connected to the HDMI terminal 1731A, the microcomputer 1735 controls the SW 1732 in such a way that the output of the HDMI terminal 1731A can be input into the MHL processor 175A or 175B.

If it is determined that an MHL cable is connected to the HDMI terminal 1731B, the microcomputer 1735 controls the SW 1732 in such a way that the output of the HDMI terminal 1731B can be input into the MHL processor 175A or 175B.

If it is determined that an MHL cable is connected to the HDMI terminal 1731C, the microcomputer 1735 controls the SW 1732 in such a way that the output of the HDMI terminal 1731C can be input into the MHL processor 175A or 175B.

If it is determined that an MHL cable is connected to the HDMI terminal 1731D, the microcomputer 1735 controls the SW 1732 in such a way that the output of the HDMI terminal 1731D can be input into the MHL processor 175A or 175B. Thus, the microcomputer 1735 controls the SW 1732 in such a way that the output of the HDMI terminal 1731 connected to an MHL cable can be input into the MHL processor 175A or 175B.

With the above structure, the wired communication module 173 can input the stream supplied from a source device by the HDMI terminals 1731 into the MHL processor 175A or 175B. Moreover, in the wired communication module 173, as the connection of the plurality of HDMI terminals 1731 to the MHL processor 175A or 175B is changed by the switch, the stream supplied to one of the plurality of HDMI terminals 1731 can be processed by the MHL processor 175A or 175B.

If an MHL cable is newly connected to one of the HDMI terminals 1731, the microcomputer 1735 determines whether or not there is an MHL processing module configured to execute a process. In other words, the microcomputer 1735 determines whether or not there is an MHL processing module which is not connected to the HDMI terminals 1731.

There is no MHL processing module which is not connected to the HDMI terminals 1731, in other words, if each of the MHL processing modules 175A and 175B is connected to one of the HDMI terminals 1731, the microcomputer 1735 controls the SW 1732 in such a way that one of the MHL processing modules 175 can conduct the process. Specifically, the microcomputer 1735 switches off the MHL processor 175A or 175B in order to disconnect the MHL processing module from the HDMI terminals 1731. Furthermore, the microcomputer 1735 controls the SW 1732 in order to connect the HDMI terminal 1731 newly connected to the MHL cable to the MHL processor 175.

In short, if there is no MHL 175 configured to execute the process, the wired communication module 173 switches off the already-established connection of the HDMI terminal 1731 to the MHL processor 175. Further, the wired communication module 173 connects the HDMI terminal 1731 newly connected to the MHL cable to the MHL processor 175 whose connection is switched off.

The microcomputer 1735 may be configured to store, in a memory, etc., a primary (an earliest) order of the HDMI terminals 1731 connected to an MHL cable. In this case, the microcomputer 1735 is capable of specifying the HDMI terminal 1731 firstly connected to the MHL cable. For example, the microcomputer 1735 switches off the connection of the specified HDMI terminal 1731 to the MHL t, and connects the HDMI terminal 1731 newly connected to the MHL cable to the MHL processor 175 whose connection is cut off. In this manner, the wired communication module 173 is capable of switching off the connection of the HDMI terminal 1731 to the MHL processor 175 from the oldest connection.

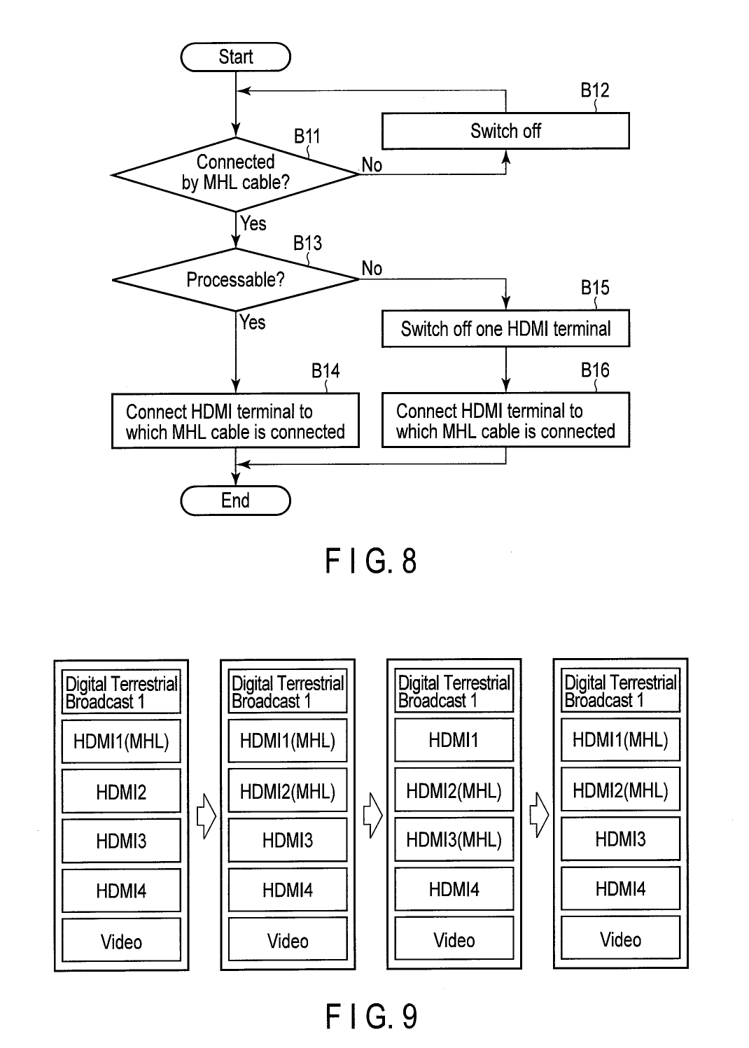

FIG. 8 shows an example of a process of the wired communication module 173 indicated in FIG. 7.

The microcomputer 1735 determines whether or not an MHL cable is connected to the HDMI terminals 1731 (block B11). If no MHL cable is connected to the HDMI terminal 1731, the microcomputer 1735 cuts off (switches off) the connection of the HDMI terminal 1731 to the MHL processor 175 (block B12).

If an MHL cable is newly connected to one of the HDMI terminal 1731, the microcomputer 1735 determines whether or not there is an MHL processing module which is executable a process (block B13). In other words, the microcomputer 1735 determines whether or not there is an MHL processing module which is not connected to the HDMI terminals 1731.

If there is an MHL processing module configured to execute the process, the microcomputer 1735 connects (switches on) the HDMI terminal 1731 newly connected to the MHL cable to the MHL processor 175 (block B14).

If there is no MHL processing module configured to execute the process, the microcomputer 1735 switches off the MHL processor 175 and the HDMI terminal 1731 which is already connected to the MHL cable (block B15). Further, the microcomputer 1735 connects the HDMI terminal 1731 newly connected to the MHL cable to the MHL processor 175 (switches on the connection of the HDMI terminal 1731 newly connected to the MHL cable to the MHL processor 175) (block B16).

With the above configuration, when an MHL cable is newly connected to the “HDMI2” while an MHL cable being connected to some other HDMI terminal “HDMI1” as illustrated in FIG. 9, the wired communication module 173 is able to connect the HDMI terminal “HDMI1” and HDMI terminal “HDMI2” to the MHL processing modules 175A and 175B, respectively.

Moreover, if an MHL cable is newly connected to the HDMI terminal “HDMI3”, the wired connection module 173 switches off the connection of the previously-connected HDMI terminal “MDMI1” to the MHL processor 175. Further, the wired communication module 173 connects the HDMI terminal “HDMI3” to the MHL processor 175.

The wired communication module 173 may be configured to, if the MHL cable connected to the HDMI terminal 1731 is pulled out, reconnect the MHL processor 175 to the HDMI terminal 1731 whose connection is most recently cut off by reference to the memory.

For example, if the MHL cable is newly pulled out from the HDMI terminal “HDMI3”, the wired communication module 173 reconnects the MHL processor 175 to the HDMI terminal “HDMI1” whose connection is most recently cut off.

With the above configuration, the user does not need to connect another MHL cable. As a result, it is possible to provide a receiving device, transmitting device and receiving/transmitting system of lower cost and high convenience.

The functions explained in each of the above embodiments are not limited to structures using hardware. These functions can be also implemented by having a computer read a program describing each of the functions by the use of software. Each function may be configured by appropriately selecting software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A device configured to receive a stream from another device, the device comprising:
a plurality of High-definition Multimedia Interface (HDMI) terminals configured to connect to a Mobile High-definition Link (MHL) cable;
a plurality of MHL processors configured to process signals of a stream received by the plurality of HDMI terminals in compliance with a MHL standard; and
a switch configured to switch a connection between the plurality of HDMI terminals and one of the plurality of MHL processors based on whether the MHL cable is connected to the plurality of HDMI terminals.

2. The device of claim 1, wherein the switch is configured to switch over the connection between the plurality of HDMI terminals and the plurality of MHL processors based on whether the MHL cable is connected to plurality of HDMI terminals.

3. The device of claim 2, wherein the switch is configured to switch off one of the plurality of HDMI terminals and the plurality of MHL processors when a signal-processable MHL processor is absent among the MHL processors and reconnect a first HDMI terminal of the plurality of HDMI terminals to the MHL processor, the first HDMI terminal connected to the MHL cable.

4. A device configured to transmit a stream to another device, the device comprising:
a stream generating unit configured to generate a stream to transmit to another device; and
an output configured to output the stream to the another device by a Mobile High-definition Link (MHL) cable in compliance with an MHL standard.

5. A system comprising a first device configured to transmit a stream by a Mobile High-definition Link (MHL) cable in compliance with a MHL standard and a second device configured to receive the stream from the first device by the MHL cable, wherein
the first device further comprises:
a stream generating unit configured to generate the stream; and an output configured to output the stream to the second device, and
the second device further comprises:
a plurality of High-definition Multimedia Interface (HDMI) terminals configured to connect to the MHL cable;
a plurality of MHL processors configured to process signals of the stream received by the HDMI terminals in compliance with the MHL standard; and
a switch configured to switch a connection between the plurality of HDMI terminals and one of the plurality of MHL processors based on whether the MHL cable is connected to the plurality of HDMI terminals.
